(19) United States
(12) Patent Application Publication
(10) Pub. No.: US 2008/0300938 A1
(43) Pub. Date: Dec. 4, 2008

(54) SYSTEM AND METHOD FOR CONTROL AND ADAPTATION OF CARRIER INFRASTRUCTURE AND PROCESS USING FORMAL CARRIER PRODUCT DEFINITION

(75) Inventors: Leon A. Pintsov, West Hartford, CT (US); Andrei Obrea, Seymour, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 12/100,443

(22) Filed: Apr. 10, 2008

Related U.S. Application Data
(60) Provisional application No. 60/932,134, filed on May 29, 2007.

(51) Int. Cl. G06Q 10/00

(52) U.S. Cl. 705/7

(57) ABSTRACT

An automated process that allows the posts to obtain a computer description of mailer's requirements for new carrier products and a description of available carrier operational constraints and capabilities in computer processable format; translating the mailer's requirements for the new carrier products into a sequence of computer actionable instructions that may be exercisable by carrier operations; and comparing by the computer the sequence of computer actionable instructions and the carrier operational constraints and capabilities to determine feasibility of the mailers requirements.

This Application claims the benefit of the filing date of U.S. Provisional Application No. 60/932,134 filed May 29, 2007, which is owned by the assignee of the present Application.

### FIELD OF THE INVENTION

This invention relates to mailing systems and more particularly to the creation of new postal products and the modification of existing postal products.

### BACKGROUND OF THE INVENTION

Governments have created postal services for collecting, sorting and distributing the mail. It is difficult for government and private postal services to define and supply new services to the public. The postal service produces and performs operations on a physical item called a mail unit and obtains detailed information about operations and supplying this information to end users i.e., senders and recipients. The postal service or post office communicates product features geared to humans not machines. Humans are inefficient to change, machines more readily accept changes.

Traditional postal product like first class and standard mail can be defined and explained in simple terms and therefore end users do not have problems creating mail for first class and standard mail services. With increased sophistication of postal products and associated requirements effective use of new postal products by mailers is hindered by the lack of automation.

In the current economic and political environment many national posts are in competition with other carriers and are having difficulty meeting their operations budget. Therefore many posts would like to become more profitable and supply additional products and services to their customers.

Thus, one of the problems of the prior art is that many posts want to know what new products and services to supply to their customers. Unfortunately the posts have no way of determining what new products and services to offer.

An additional problem of the prior art is that if the posts knew what new products and services to supply to their customers they had no way of determining whether or not the new products and services may be accomplished using the constraints imposed by the posts current network processes and equipment.

In the environment of this invention the term carrier refers to the environment whereby physical items are inducted, processed, transported and delivered via a distribution network. In this application the terms postal and carrier are used interchangeably and refer to national post offices, couriers delivery services and any entity that delivers mail and/or packages.

### SUMMARY OF THE INVENTION

This invention overcomes the disadvantages of the prior art by creating an automated process that allows the posts to determine what new products and services their customers want and whether or not the new products and services may be accomplished using the constraints imposed by the posts current network processes and equipment. The foregoing is accomplished by creating an automated process that: collects from mailers a description of new products and services the mailers would like to have; summarizes the description of new products and services in terms of postal products and services that would have a broad appeal; and determines the feasibility of new products and services within existing constraints. Alternatively the posts may change or modify existing constraints to offer new products and services.

The invention describes a formal mechanism for defining a broad variety of postal products using measurable attributes. The mechanism for the products then may be formalized into data structures and procedures executable by computer systems.

The postal products from the senders prospective contains physical elements. The physical elements of the mail unit are physical parameters “dimensions, volume, density, material characteristics and content”. Content is restricted for certain services for instance you cannot mail liquids or powders. The physical elements also include the geography of induction, geography of delivery of the mail unit, routing information, i.e., the options for selecting a route between induction and delivery points and timing and frequency of collection and delivery of the mail unit.

The informational elements of the postal product from a sender's perspective include the following: sender directed information about events that occurred during the mail unit processing; sender directed information about other mail units that are directly linked to the mail unit that is being served; sender directed information about objects directly linked to the mail unit being served; customer directed information about other mail communications, sent, received or replied by sender and recipient directed information about the mail unit; and customer service provider negotiated information defining remedies for instances when service could not be delivered as specified.

The sender may also specify rules expressing desired conditions imposed on physical and informational elements.

Regarding informational elements the customer may supply directed information about events in their corresponding attributes that occurred during mail unit processing. Information describing significant changes in values of attributes of the mail unit being served, including information concerning events as deposit, delivery, receipt, impossibility of delivery, mail unit damage or discarding information concerning defects of the mail unit obtained as a result postal processing including such attributes of mail unit as its digital image or digital image of its content.

The standard of evidence required from a sender's perspective may include defining the information security services for presentation of events information to the sender in both physical and electronic format. Evidence of the data origin authentication, data integrity and privacy may also be required.

The following are other examples of events from a senders perspective: depositing of the mal unit; delivery of the mail unit into recipients mailbox; delivery of the mail unit to the recipient; refusal of the mail unit by the recipient; forwarding of the mail unit to another party; diverting and sending the mail unit to another facility; returning the mail unit to the sender; and destroying the mail unit.

Informational elements customer directed information about other mail units that are directly linked to the mail unit that is being served. Information concerning the whereabouts of reply mail units that is mail items sent by the recipient of the given mail unit as a response to receiving it. Customer directed information about other objects directly linked to the mail unit being served. Information about the structure “building, post office box” identified in the destination address, information about intended or actual recipient of the mail unit.

Informational elements. Customer directed information about other mail communications sent, received or replied to by sender or recipient. Information how many directed mail units has been replied to by the recipient identified in the address block. Recipient directed information about the mail unit. Notification about up coming delivery or problems with delivery. Any invaluable to recipient information typically not available to sender at the time of mail unit creation. Customer service provider negotiated information defining remedies when service could not be delivered as specified. Insurance for lost items or refunds for late delivery in similar occurrences and events.

The following is an example of rules from a sender's perspective. If given mail unit cannot be delivered destroy it and send the digital image of the mail unit back to the sender.

If given mail unit cannot be delivered before this date/time, return mail unit and credit mailers account. If given mail unit is located in this facility, do not deliver it but send a digital image of the content and identity of the mail unit to this e-mail address. If given mail item unit is located in this facility after this date, send mail unit to different address. If given mail unit weighs less than the given value “e.g. 20 grams.”Send a digital image of the mail unit to the sender or notify the sender by electronically sending the mail unit identifier and the value of the attribute named for instance weight.

The following describes a postal product from a postal operator's perspective. The postal product contains physical elements, informational elements and rules, i.e., access requirements. The mail unit makeup “data elements, format emplacement” computerized information to accompany the mailing, its timing, messaging and protocol requirements. Grouping and containerization requirements i.e., presort and packaging rules. Pricing and payment requirements.

The above example is intended to convey two basic thoughts. First, an open innovation model for postal products requires a platform and formal language for defining these products. Another element of Action 551 is monetary action MonetaryAction 522. There could be one or more monetary actions. The monetary action 522 in our example takes an amount Amount 507 calculated using a formula AmountCalculation 529 and transfers it to the party identified in PartyID 531 at a time specified by TimingOfAction 530. In our case the PartyID 531 is the mailer 508 who will receive compensation for a damaged mail item.

The term “mailer” refers to the mailer or parties acting on behalf of the mailer. Examples of tasks fulfilled by the mailer are: selection and creation of the mail units, printing the mail units, folding, inserting, franking, packing and induction of the mail units. The term “requirements” is derived from business needs and refers to desires or needs of the communicator wants, i.e., delivery time for the communication, proof of delivery, costs, color and material of the mailing envelope and insert and the availability of the color and material of the mailing envelope and insert. The term “constraints” refers to a set of restrictions imposed on the physical composition of the mail units in terms of their attributes (names, values), i.e., location and size of address block, position and encoding scheme for the identifier,. Likewise, their may be constraints on sending and receiving information in electronic form to and from other parties, i.e., timing format protocols, etc.

### BRIEF DESCRIPTION OF THE DRAWINGS

FIG. 1 is a system diagram of this invention;

FIG. 2 is a diagram of the content and the structure of a carrier product represented as a XML document;

FIG. 3 is a flow chart describing the process utilized by computer 142 of FIG. 1, and

FIG. 4 a flow chart describing how a mail unit receives a product and service that was requested in FIG. 3.

### DETAILED DESCRIPTION OF THE INVENTION

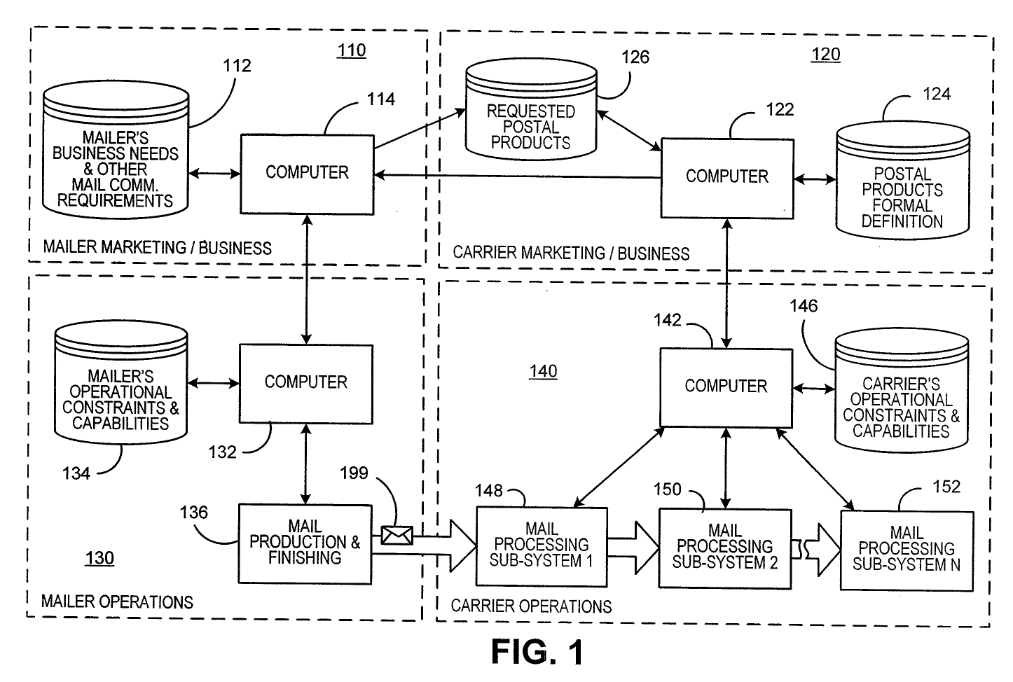

Referring now to the drawings in detail and more particularly to FIG. 1, the reference character 110 represents mailer's marketing and business operations. Mailer's marketing and business operations include mailer's business needs and other mail communications requirements data base 112 that contains formal computer processable information regarding the mailer's needs and other requirements and computer 114 that is coupled to data base 112. Mailer's operations 130 includes mailer's operational constraints and capabilities data base 134 ; computer 132 and mail production and finishing 136, that may include document and envelope printers, inserters, postage meters, etc. that produce mail unit 199. Computer 132 is coupled to data base 134, mail production and finishing 136 and computer 114. Database 134 contains formal computer processable information regarding the mailer's, constraints and capabilities i.e., a set of restrictions imposed on the physical composition of the mail units in terms of their attributes, i.e., location and size of address block, position and encoding scheme for the identifier, color and material of the mailing envelope and insert. Likewise, in database 104 there may be constraints on sending and receiving information in electronic form to and from other parties, i.e., timing format protocols, etc. Mail unit 199 will enter mail processing sub-system 148.

Carrier marketing and business operations 120 includes mailer's requested postal products that do not currently exist but are desired by mailer's data base 126, computer 122 that is coupled to data base 126 and data base 124 that contains a formal description of carrier's products and services i.e., rules pertaining to what mail units may be sent and what they may contain, i.e., delivery time, area of collection and delivery, how sorted, read, print, unbundled, bundle, price, etc. Computer 122 is also coupled to computer 114 and computer 142 contained in post operations 140.

Post operations 140 also includes post's operational constraints and capabilities data base 146 that is coupled to computer 142, mail processing sub-system 148, mail processing sub-system 150 and mail processing subsystem 152. Mail processing sub-system 148, mail processing sub-system 150 and mail processing subsystem 152 are coupled to computer 142 and contain postal processing equipment, i.e., facer canceller, optical character recognition equipment, sorters, delivery equipment, etc.

The marketing department of a business may desire to enter new desired postal products and services into computer 114 which will be stored in data base 112. Some examples of new desired products and services are as follows. The mailer wants promotional invitations to be delivered to recipients around the country in exactly two days after the promotional mail units were inducted into by the post. The mailer wants the post to process mail units having round envelopes and/or having a particular color. The mailer wants the post to process mail units having art work, i.e., famous paintings printed over a defined portion of the face of the envelope. The mailer wants the post to track a plurality of business reply envelopes from the moment they are inducted by the post and the mailer wants to be notified by e-mail when the post processes the business reply envelopes. When desired by the mailer computer 114 will transmit the mailer desired new products and services stored in data base 112 to data base 126 Computer 122 collects the requests from data base 126 and communicates them to computer 142. Computer 142 communicates with data base 146 which contains of formalized description of the carrier operational constraints and capabilities and computer 142 then determines whether or not the post may be able to perform the new request.

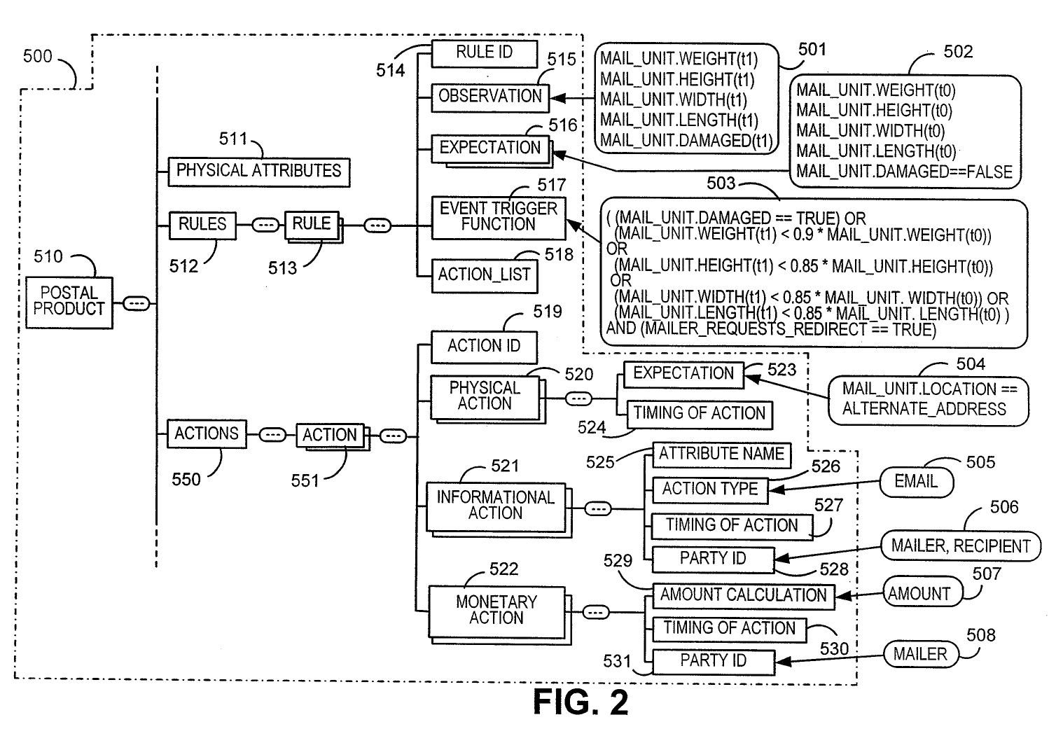

FIG. 2 is a diagram of the content and the structure of a carrier product represented as a XML document. The XML schema that is designed for the product description can serve as a common language of the open innovation process. In this context it is known under the name “Extensible Postal Product Model and Language” (EPPML). The EPPML is a dynamic standard adaptable to emerging requirements for new products and new data exchanges.

FIG. 2 illustrates a fragment of an XML document which is a postal product definition file. In this example, the postal product has an added feature that monitors the size and weight of a mail item and triggers a warning when either of them changes. Such change is considered an indication of possible damage to the mail item. Consider a business mailer that receives merchandise from a supplier in China and then sells it via mail order and ships it using a postal service provider. The mailer notices that as a result of multiple handlings the merchandise (a mail item) sometimes arrives damaged generating undesirable and costly returns processing and multiple unnecessary communications with the intended recipients. The mailer therefore is interested in having the post detect and segregate damaged mail items before delivery to the recipients, redirecting damaged items to the mailer's repair facility. The mailer further wishes that the post, upon detection of the damaged mail item, would notify the recipient and the merchant's repair facility using email. Finally if the damage noted is the result of improper handling by the post the mailer may wish in some instances to receive agreed upon monetary compensation from the post. The post discovers that this mailer' needs are not uncommon and offers a new product intended to meet the requirements of an entire segment of mailers with similar needs. This product is expressed formally using a XML document illustrated in FIG. 2.

In the FIG. 2, t0 denotes the original mailing (induction) time and t1 some later time at which a damage condition is detected.

Referring to FIG. 2 block 500 represents the structure of the XML document. The structure of the document is described by the elements contained in block 500. The values of the elements are shown outside block 500. Note that the names of the elements in the XML document are constrained by the standard rules that do not allow the use of spaces; as a result, names are sometimes created by concatenating two or more words without spaces between them. The root of the XML document that describes the postal product in our example is PostalProduct 510. Elements at the next level are, in this example, PhysicalAttributes 511 which contains mail item attributes that describe the physical nature and characteristics of the mail item (for example weight, width, length), Rules 512 which contains one or more elements Rule 513. Each Rule 513 contains a RuleID 514 which is a unique identifier for that rule, one or more Observation 515 which contains a set of values of mail item attributes taken at a given time t. An example of an observation is given in block 501 where the attributes of mail_unit are observed at time t1. The attributes of the mail item identified as mail_unit at time t1 are: weight mail_unit.weight(t1), height mail_unit.height(t1), width mail_unit.width(t1), length mail_unit.lenght(t1) and a boolean attributed labeled damaged mail_unit.damaged(t1).

For example, the following occurrences might be used as indicators that a mail item is damaged: a) 10% or larger change in the weight of the mail item, or b) 13% or larger change in any dimension of the mail item (height, length, or width). Finally, of course, damage can be detected by human operators via visual observation indicating that the mail item appears damaged (punched, defaced, etc.). In each case, the damage causes a detectable change in the value of one or more attributes of the mail item.

The names of the attributes of the mail item that change their value as a result of the handling damage are weight, height, length, width, and damaged (the last attribute takes two values true or false). As long as these attributes indicating “damage condition” can be stated formally, they can be implemented by production rules that are easily programmed in the EPPML. Thus, “damage events” are detectable if significant changes occur in any of the aforementioned mail item attributes. The occurrence of the damage events can be computed by comparing observations and expectations taken at different moments in time. The element expectation 516 has values of mail_unit attributes that for this application are not expected to change (no damage). The expectation is that the values of mail_unit attributes are the same as the initial values, which is at t0, as shown in block 502 which are: weight mail_unit.weight(t0), height mail_unit.height(t0), width mail_unit.width(t0), length mail_unit.lenght(t0) and a boolean attributed labeled damaged mail_unit.damaged(t0).

The main portion of the rule description is the event trigger function EventTriggerFunction 517 that detects the occurrence of the event and the list of actions to be undertaken after the event has occurred and has been detected. While we have focused on “damage events” in this example, it should be clear that other events of relevance to the mailer or the recipient could also be programmed in the same manner. The event trigger function takes as input values of observations (e.g. observation 515) and expectations (e.g. expectation 516). In our example, the EventTriggerFunction 517 contains the following expression shown in block 503, namely: ((mail_unit.damaged==true) or (mail_unit.weight(t1)<0.9*mail_unit.weight(t0)) or (mail_unit.height(t1)<0.85*mail_unit.height(t0)) or (mail_unit.width(t1)<0.85*mail_unit.width(t0)) or (mail_unit.length(t1)<0.85*mail_unit.length(t0)) and (mailer_requests_redirect==true).

The element Action_List 518 contains a list of actions to be taken by the post upon detection of an event indicating damage of the mail item. This list typically contains one or more ActionID 519.

Another element of the PostalProduct 510 is Actions 550 which contains one or more elements Action 551. Each Action 551 contains a unique identifier ActionID 519, one or more physical actions PhysicalAction 520, one or more informational actions InformationalAction 521 and one or more monetary actions MonetaryAction 522.

In order to deliver the new “damage reporting product” described above, the post would need an alternate address (i.e. the address of the mailer's repair facility), the desired amount of the compensation (within the limits set up by the post) and email addresses of the mailer and the recipient. These elements must be provided by the mailer in or out-of-bound (i.e. directly on the mail item or electronically). In our example, the action to be taken upon discovery of damage includes delivery at an alternate address provided as a new expectation Expectation 523 which includes the value of the alternate address 504. The physical action also includes an indication regarding the timing of the physical action TimingOfAction 524 which is a moment in time.

Another element of Action 551 is an informational action InformationalAction 521. There could be one or more informational actions. The informational action refers to an attribute whose name is specified by AttributeName 525 and whose value is to be acted upon as a result of Action 551. An informational action can be sending an email, a fax, a SMS, etc. The type of the informational action is specified in ActionType 526. In our example, the post will send an email to both the mailer and the recipient. The values of action type 526 and party ID 528 are shown in 505 and 506. The time of sending an email in our example is specified by the element TimingOfAction 527.

In the terminology of product innovation, this platform and language make the definition of new products “codifiable”. This means that the product can be communicated in a clear and transparent manner between customers and postal service providers and their computers. The second thought conveyed by the example is that designing a platform to assure open innovation is achievable for a broad array of postal products. Thus, the approach here is a viable method for creating descriptions of a broad variety of products that are suitable for both human and computer processing, providing thereby a common language that is a prerequisite for the open product innovation. We name this language EPPML (extensible postal product model and language).

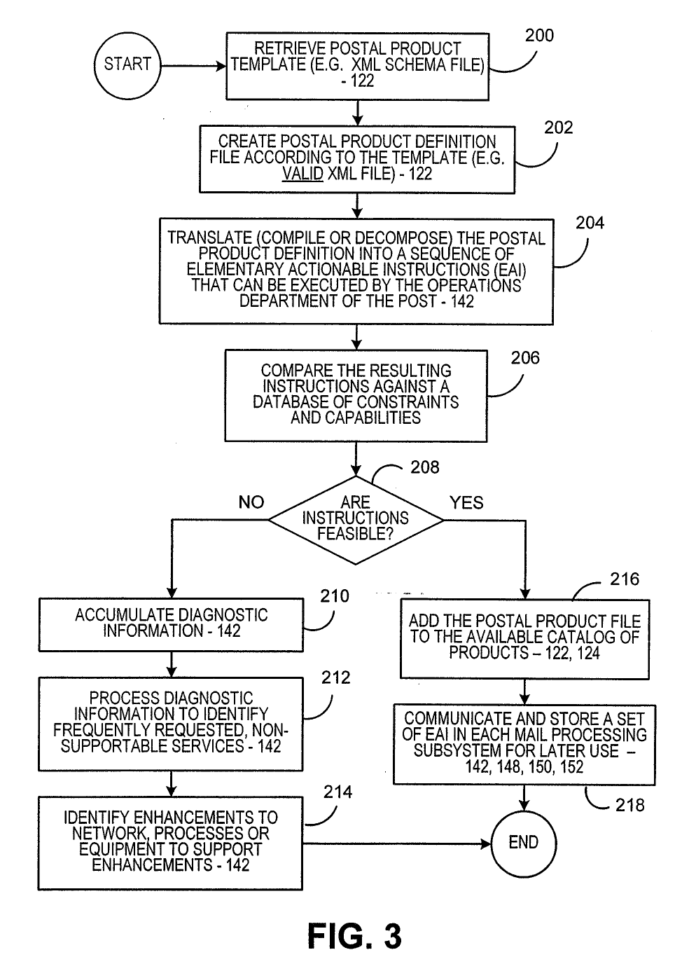

FIG. 3 is a flow chart describing the process utilized by computer 142 of FIG. 1. After the process starts the first step is step 200 where the post retrieves a postal product template, eg. XML schema file. It is customary for an XML schema file to use the extension XSD. We will refer to an XML schema file as an XSD file. The next step in the process is step 202 the creation of a postal product definition file according to the template, i.e., a valid XML file. Step 202 is driven by: the business needs of the post as set forth in data base 124 (FIG. 1). Data base 124 stores requests from mailers for specific products stored in data base 126 submitted to the post according to the postal product definition schema stored in computer 122 and data base 124. Next step 204 translates (compile or decompose) the postal product definition into a sequence of elementary actionable instructions (EAI) that can be executed by the operations department of the post.

The post operations department maintains a database 146 of posts capabilities and constraints that is retrieve by computer 142. Examples of constraints on both mail unit and postal processing subsystems are: limitations of barcode readability, limitation of transit time, pickup and delivery areas and time-of-day and thickness of an envelope for automated sorters. Examples of such elementary instructions are: identify the postal product requested for given mail unit; retrieve mail unit identity; read barcode (symbology, location), read radio frequency identification device (RFID), read handwritten text; measure mail unit dimensions, weight, color; retrieve the content of the Destination Address Block of the mail unit; modify the destination address information; transport mail unit; print identifier on mail unit (on the face/back, content, symbology, location); accept mail unit; deliver mail unit; sort mail unit; communicate exceptions, tracking information, issue refunds, extra charges; verify that the resulting instructions are feasible by comparing them against the database of constraints and capabilities; if successful, store validated XML file which represents the postal product; if failure, report the diagnostic information (inability of the network, process or equipment to perform requested EAI). The EAI is also communicated and stored in each mail processing subsystem for later use, i.e., computer 142 (FIG. 1), and sub-systems 148,150, and 152

At this point step 206 compares the resulting instructions against data base 146 (FIG. 1) constraints and capabilities, i.e., can the post process round envelopes. The next step in the process is step 208. Step 208 determines whether or the instructions are feasible. If step 208 determines that the instructions are not feasible the next step is step 210. Step 210 accumulates diagnostic information in computer 142. Next step 212 processes the diagnostic information to identify frequently requested, non-supportable services and stores the result in computer 142. Then step 214 identifies the enhancements to the network, processes or equipment to support the enhancements. In other words step 214 informs the post of changes that may be made to their sub-systems to make new products and services possible.

If step 208 determines that the instructions are feasible the next step is step 216. Step 216 adds the postal product file to the available catalog of products controlled by computer 122 and stored in data base 124. Then step 218 communicates and stores a set of EAI in computer 142 and in mail processing sub-systems 148, 150 and 152 for later use. After completing step 214 or step 218 the process ends.

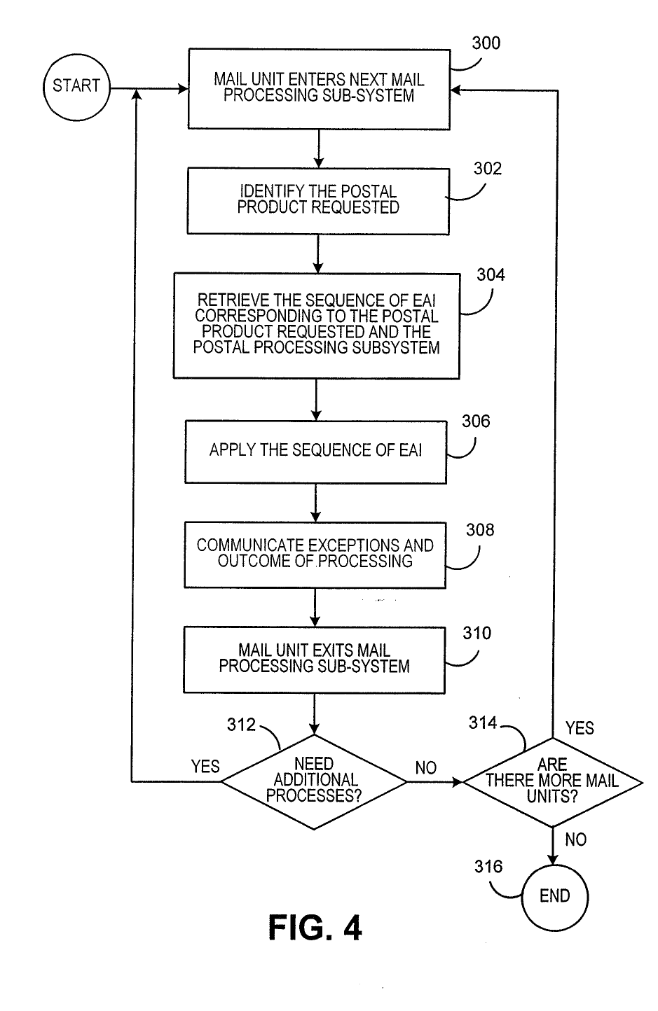

FIG. 4 is a flow chart describing the processing of a mail unit in the carrier operations 140 in accordance with the elementary actionable instructions (EAI) identified in FIG. 3 for the carrier product identified on the mail unit 199. After the process starts the first step is step 300, where the mail unit enters the next mail processing sub-system. The next step is step 302, where the identity of the postal product is requested. At this point the process goes to step 304. Step 304 retrieves the sequence of EAI corresponding to the postal product requested and the postal processing subsystem. Then in step 306 the process applies the sequence of EAI. Now in step 308, the process communicates exceptions and the outcome of processing. The next step is step 310 where the mail unit exits the mail processing subsystem. The next step in the process is step 312. Step 312 determines whether or not any additional processes are needed. If step 312 determines that additional processes are needed the process goes back to step 300. If step 312 determines that additional processes are not need the process goes to step 314. Step 314 determines whether or not there are more mail units. If step 314 determines that there are more mail units the process goes back to step 300. If step 314 determines that there are no more mail units the process ends in step 316.

The above specification describes a new and improved method for automating the creation of new postal products and the modification of existing postal products. It is realized that the above description may indicate to those skilled in the art additional ways in which the principals of this invention may be used without departing from the spirit. Therefore, it is intended that this invention be limited only by the scope of the appended claims.

What is claimed is:

1. A method for creating new carrier products or the modification of existing carrier products, said method comprises the steps of:
obtaining by a computer a description of requirements for new carrier products and a description of available carrier operational constraints and capabilities in computer processable format;
translating the requirements for the new carrier products into a sequence of computer actionable instructions that may be exercisable by carrier operations; and
comparing by the computer the sequence of actionable instructions and the carrier operational constraints and capabilities to determine feasibility of the requirements.

2. The method claimed in claim 1, wherein the computer description of requirements is a computer description of mailer requirements.

3. The method claimed in claim 2, further including the step of:
identifying the carrier operational constraints and capabilities that render the requirements for new carrier products not feasible,
identifying enhancements to the carrier operations that remove the carrier operational constraints; and
implementing the carrier operations enhancements.

4. The method claimed in claim 2, further including the step of:
adding a description of the new carrier product to available carrier products if feasible.

5. The method claimed in claim 1, wherein the computer description of requirements is a computer description of carrier requirements.

6. The method claimed in claim 5, further including the step of:
identifying the carrier operational constraints and capabilities that render the requirements for new carrier products not feasible,
identifying enhancements to the carrier operations that remove the carrier operational constraints; and
implementing the carrier operations enhancements.

7. The method claimed in claim 5, further including the step of:
adding a description of the new carrier product to available carrier products if feasible.

8. The method claimed in claim 1, wherein the computer description of requirements is a combination of the computer description of mailer and carrier requirements.

9. The method claimed in claim 8, further including the step of:
identifying the carrier operational constraints and capabilities that render the requirements for new carrier products not feasible,
identifying enhancements to the carrier operations that remove the carrier operational constraints; and
implementing the carrier operations enhancements.

10. The method claimed in claim 8, further including the step of:
adding a description of the new carrier product to available carrier products if feasible.
